(19) United States
(12) Patent Application Publication
(10) Pub. No.: US 2003/0112850 A1
(43) Pub. Date: Jun. 19, 2003

(54) Wireless communication apparatus having an acquisition circuit and the method thereof

(76) Inventor: Yoshihito Shmazaki, Kanagawa (JP)

Correspondence Address: VOLENTINE FRANCOS, PLLC, Suite 150, 12200 Sunrise Valley Drive, Reston, VA, 20191, US

(21) Appl. No.: 10/318,236

(22) Filed: Dec. 13, 2002

(30) Foreign Application Priority Data
Dec. 13, 2001 (JP) 380443/2001

(51) Int. Cl. H04K 1/00

(52) U.S. Cl. 375/134

(57) ABSTRACT

A wireless communication apparatus having an acquisition circuit in CDMA system, wherein the acquisition circuit has a partial correlation portion which generates a first correlation value, a comparator portion which compares the first correlation value and a threshold value and outputs a comparison result and a clock signal control portion which supplies a clock signal to the partial correlation portion based on the comparison result.

### BACKGROUND OF THE INVENTION

1. Field of the Invention

The present invention relates, in general, to a wireless communication apparatus and, more particularly, to a wireless communication apparatus having an acquisition circuit in the Code Division Multiple Access (CDMA) system.

This application is a counterpart of Japanese patent application, Serial Number 380443/2001, filed Dec. 13, 2001, the subject matter of which is incorporated herein by reference.

2. Description of the Related Art

The conventional wireless communication apparatus is shown in Japanese Patent Application Laid-open No. 2001-24558 and No. 2000-138654.

The conventional wireless communication apparatus having an acquisition circuit will be described in FIGS. 16 and 17. FIG. 16 is a block diagram showing the conventional wireless communication apparatus having an acquisition circuit. FIG. 17 is a block diagram showing a partial correlation portion of the acquisition circuit in the conventional wireless communication apparatus.

The Conventional wireless communication apparatus comprises with an antenna 1610, a radio portion 1620, an acquisition circuit 1630 and a clock signal generating circuit 1640. The acquisition circuit 1630 comprises with a plurality of partial correlation portions 1631-1634 and a searcher circuit 1635. As shown in FIG. 17, each partial correlation portion comprises with a correlation calculating portion 1710, a code generating portion 1720 and a correlation value storing portion 1730.

The conventional wireless communication apparatus has a plurality of partial correlation portions and carries out a parallel operation using the partial correlation portions to effectively acquire system synchronization. An operation of each partial correlation portion will be explained as follows. The correlation calculating portion 1710 of the partial correlation portion calculates a correlation value 1710a using a digital signal 1620a which is modulated to a base band signal and a spreading code 1720a which is generated in the code generating portion 1720. The correlation value storing portion 1730 stores the correlation value 1710a and outputs it based on the clock signal CLK.

However, the conventional wireless communication apparatus always must carry out a parallel operation using a plurality of the partial correlation portions to the very end, based on all receive signals, even if the wireless communication apparatus can not acquire system synchronization. Therefore, the conventional wireless communication apparatus requires a measurable amount of power.

### SUMMARY OF THE INVENTION

According to one aspect of the present invention, there is provided a wireless communication apparatus having an acquisition circuit in CDMA system, wherein the acquisition circuit has a partial correlation portion which generates a first correlation value, a comparator portion which compares the first correlation value and a threshold value and outputs a comparison result and a clock signal control portion which supplies a clock signal to the partial correlation portion based on the comparison result. The novel features of the invention will more fully appear from the following detailed description, appended claims and the accompanying drawings.

### BRIEF DESCRIPTION OF THE DRAWINGS

FIG. 1 is a block diagram showing a wireless communication apparatus according to a first preferred embodiment of the present invention.

FIG. 2 is a block diagram showing a radio portion according to a first preferred embodiment of the present invention.

FIG. 3 is a block diagram showing a partial correlation portion according to a first preferred embodiment of the present invention.

FIG. 4 is a block diagram showing a comparator portion according to a first preferred embodiment of the present invention.

FIG. 5 a block diagram showing a searcher circuit according to a first preferred embodiment of the present invention.

FIG. 6 a block diagram showing a control portion according to a first preferred embodiment of the present invention.

FIG. 7 is a table showing an ideal receive signal which is spread by a spreading code according to a first preferred embodiment of the present invention.

FIG. 8 is a table showing a real receive signal which is spread by a spreading code according to a first preferred embodiment of the present invention.

FIG. 9 is a table showing a timing of code generating in an acquisition circuit according to a first preferred embodiment of the present invention.

FIG. 10 is a table showing a spreading code which is generated in a code generating portion according to a first preferred embodiment of the present invention.

FIG. 11 is a table showing an operation of a multiplication portion according to a first preferred embodiment of the present invention.

FIG. 12 is a table showing an operation of an addition portion according to a first preferred embodiment of the present invention.

FIG. 13 is a block diagram showing a wireless communication apparatus according to a second preferred embodiment of the present invention.

FIG. 14 is a block diagram showing a correlation comparator portion according to a second preferred embodiment of the present invention.

FIG. 15 is a block diagram showing a conventional wireless communication apparatus.

FIG. 16 is a block diagram showing a conventional partial correlation portion.

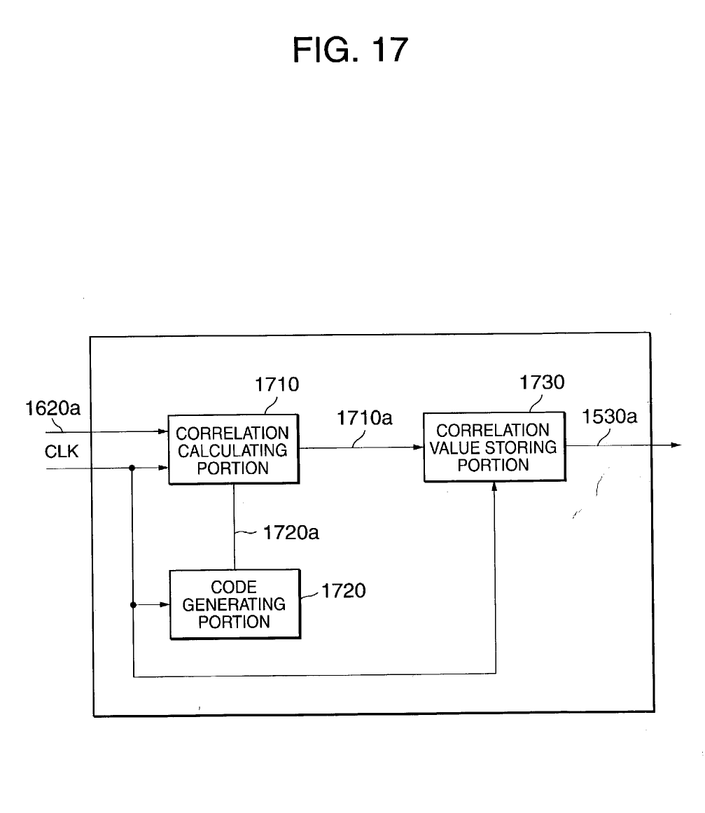

### DETAILED DESCRIPTION OF THE PREFERRED EMBODIMENTS

A wireless communication apparatus of the present invention will be explained with the preferred embodiments of the present invention. Moreover, not all the combinations of the characteristics of the present invention described in the embodiments are essential to the problem solving means by the present invention.

(First Preferred Embodiment)

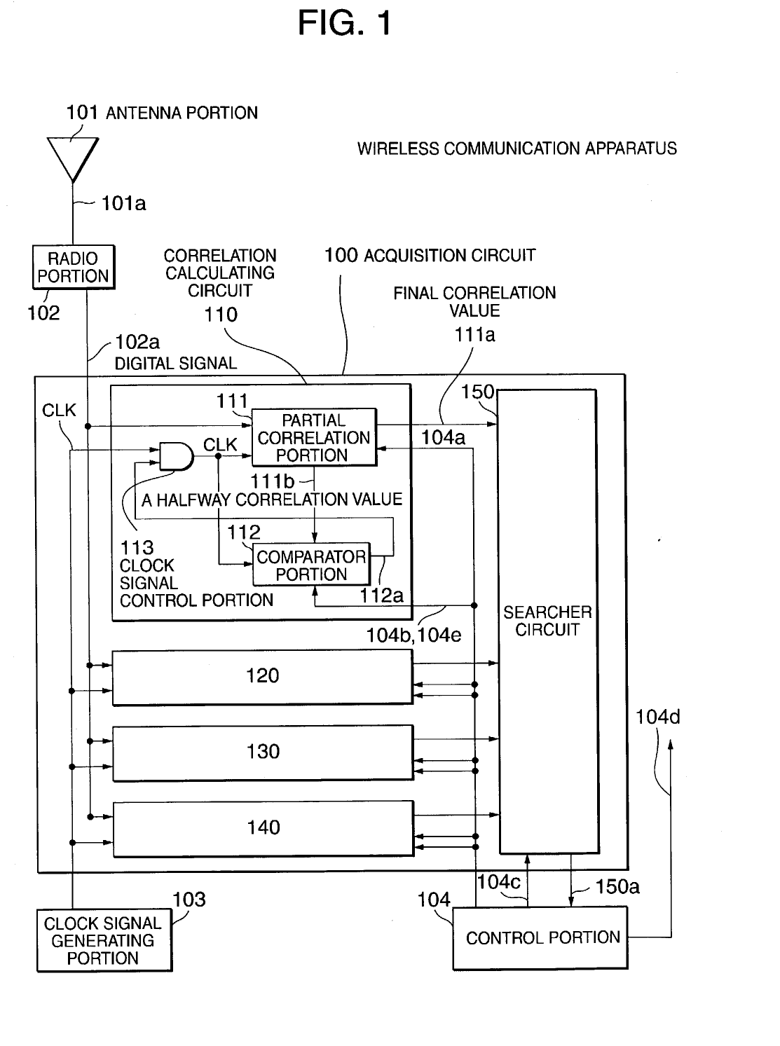

A wireless communication apparatus according to a first preferred embodiment of the present invention will be described with reference to FIGS. 1-13.

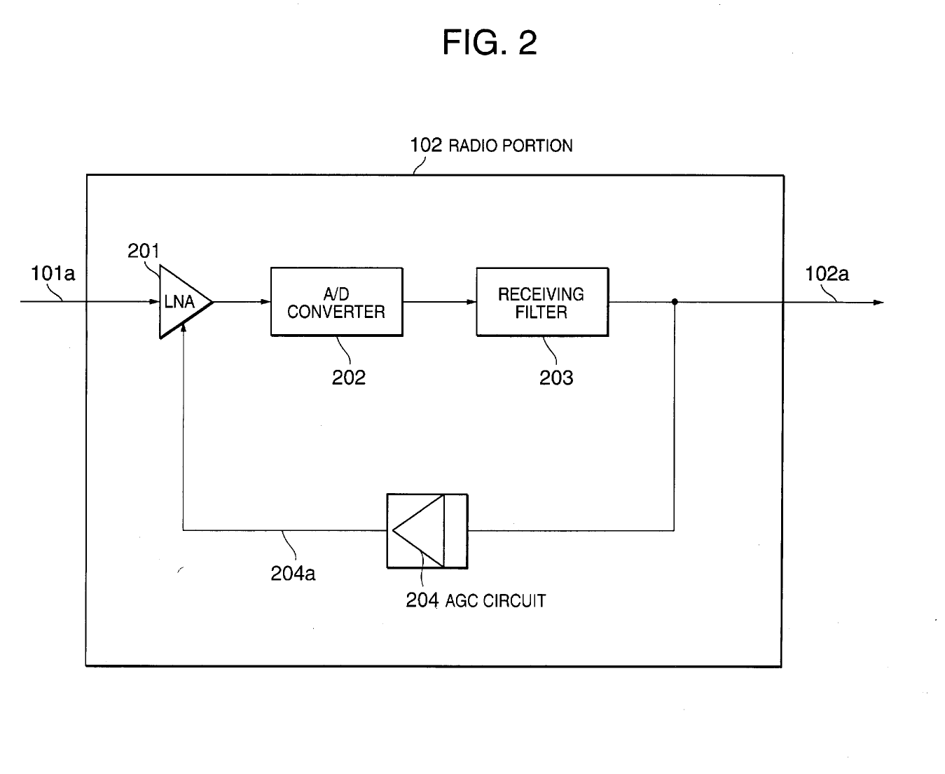

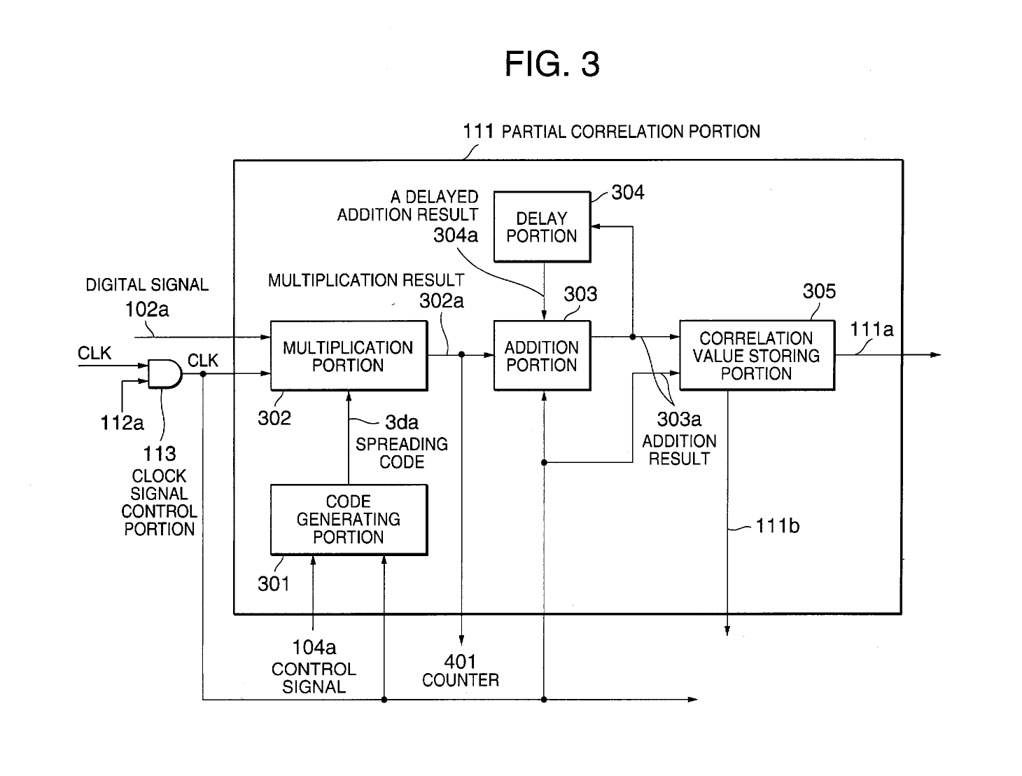

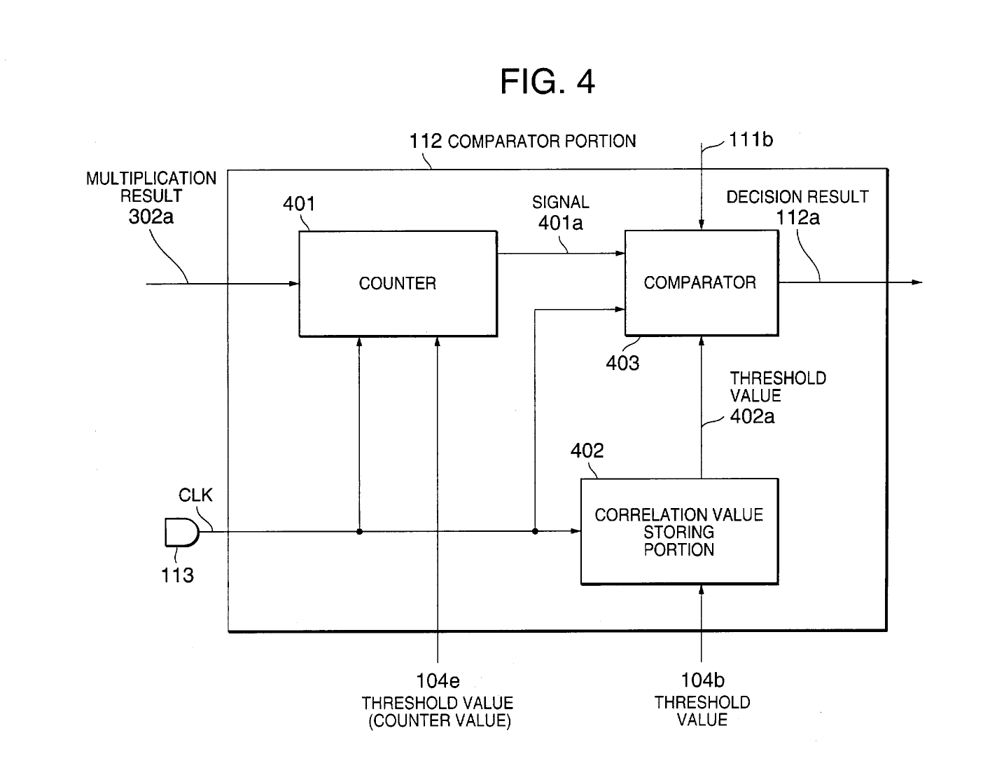

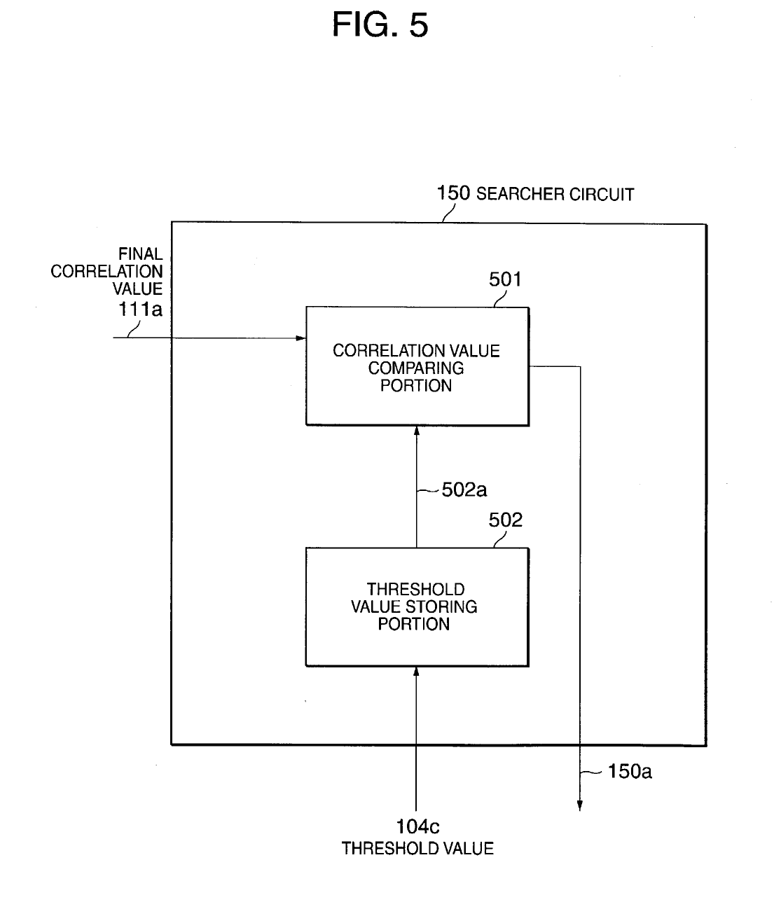

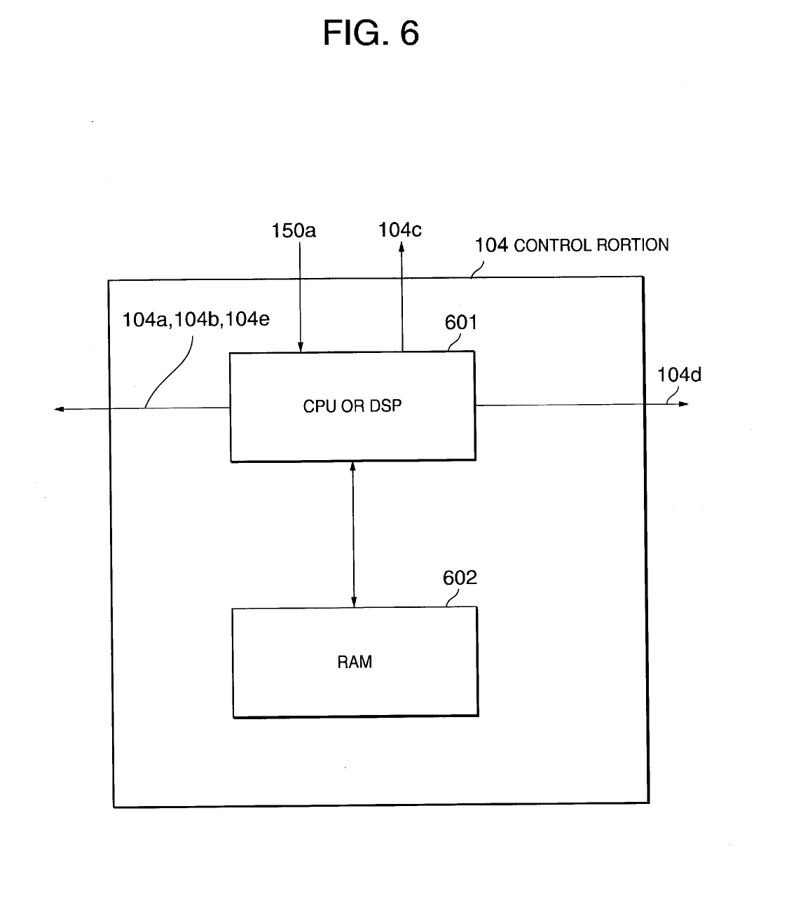

First, the composition of the wireless communication apparatus according to the first preferred embodiment of the present invention will be explained with FIGS. 1-6. FIG. 1 is a block diagram showing a wireless communication apparatus according to a first preferred embodiment of the present invention. FIG. 2 is a block diagram showing a radio portion according to a first preferred embodiment of the present invention. FIG. 3 is a block diagram showing a partial correlation portion according to a first preferred embodiment of the present invention. FIG. 4 is a block diagram showing a comparator portion according to a first preferred embodiment of the present invention. FIG. 5 a block diagram showing a searcher circuit according to a first preferred embodiment of the present invention. FIG. 6 a block diagram showing a control portion according to a first preferred embodiment of the present invention.

As shown in FIG. 1, the wireless communication apparatus has an antenna portion 101, a radio portion 102, an acquisition circuit 100, a clock signal generating portion 103 and a control portion 104.

The antenna portion 101 receives a transmitting signal which is output by the base station in the CDMA system. The signal is spread by the spreading code in the base station.

The radio portion 102 is coupled with the antenna portion 101 and input the received signal 101a. The radio portion 102 modulates the received signal 101a to a base band signal, modulates it from analog signal to digital signal and outputs the digital signal 102a. As shown in FIG. 2, the radio portion 102 has a Low Noise Amplifier (LNA) 201, an Analog-to-Digital (A/D) converter 202, a receiving filter 203 and an Auto Gain Controller (AGC) circuit 204. The received signal 101a is input to the A/D converter 202 through the LNA 201. The received signal 101a is modulated from analog signal to digital signal and outputs the digital signal 102a through the receiving filter 203. The gains of the signals 101a and 102a are controlled by the LNA 201 and the AGC circuit 204 to keep the input level P of the A/D converter 202 a steady value. When the gain of the receiving filter 203 is Q, when the gain of the correlation calculating circuit is R and when the ratio of the necessary signal to carry out an acquisition operation in the acquisition circuit 100 is W, the strength of the signal output by the correlation calculating circuit is shown in the following a mathematical expression;

P * W * Q * R (*: multiplication operation)

The above mathematical expression is calculated in the control portion 104 and the calculated value is stored in a threshold value storing portion 502 in the searcher circuit 150 in FIG. 5. For example, when P=50, W=¼ and Q=R=2,)the strength of the signal is 50 (=50*1/4*2*2).

The acquisition circuit 100 is coupled with the radio portion 102, the clock signal generating portion 103 and the control portion 104. The acquisition circuit 100 calculates a plurality of correlation value using a plurality of the correlation calculating circuits to acquire system synchronization effectively. The acquisition circuit 100 has a plurality of correlation calculating circuits 110-140 and a searcher circuit 150. Each of the correlation calculating circuits 110-140 calculates correlation value which differs from each other based on the digital signal 102a. The composition of each correlation calculating circuit is same each other. So, the composition of each correlation calculating circuit will be explained using the correlation calculating circuit 110. The correlation calculating circuit 110 has a partial correlation portion 111, a comparator portion 112 and a clock signal control portion 113.

The partial correlation portion 111 generates a spreading code, calculates a final correlation value 111a and a halfway correlation value 111b based on the digital signal 102a. The comparator portion 112 compares a threshold value and the halfway correlation value 111b and decides whether the partial correlation portion 111 keeps calculating to the very end to get the final correlation value 111a or not. The clock signal control portion 113 decides whether it lets the clock signal CLK supply to the partial correlation portion 111 and the comparator portion 112 or not, based on the decision of the comparator portion 112. The clock signal control portion 113 comprises with an AND circuit and has two input terminals and one output terminal. One input terminal is connected to an output terminal of the comparator portion 112 and the other input terminal is connected to an output terminal of the clock signal generating portion 103. The output terminal is connected to the input terminals of the partial correlation portion 111 and the comparator portion 112.

The partial correlation portion 111 is shown in FIG. 3, in detail. The partial correlation portion 111 has a code generating portion 301, a multiplication portion 302, an addition portion 303, a delay portion 304 and a correlation value storing portion 305. The code generating portion 301 generates the spreading code 301a as the base station uses, based on a control signal 104a. The code generating portion 301 has two input terminals and one output terminal. One input terminal is connected to one output terminal of the clock signal control portion 113 and the other input terminal is connected to one output terminal of the control portion 104. The output terminal is connected to one input terminal of the multiplication portion 302. The multiplication portion 302 carries out the multiplication operation of the digital signal 102a and the spreading code 301a and outputs the multiplication result 302a. The multiplication portion 302 has three input terminals and one output terminal. One input terminal is connected to one output terminal of the radio portion 102, another input terminal is connected to one output terminal of the clock signal control portion 113 and the other input terminal is connected to one output terminal of the code generating portion 301. The output terminal is connected to the input terminals of the addition portion 303 and the counter 401. The addition portion 303 carries out the addition operation of the multiplication result 302a and a delayed addition result 304a and outputs an addition result 303a. The addition portion 303 has three input terminals and one output terminal. One input terminal is connected to one output terminal of the multiplication portion 302, another input terminal is connected to one output terminal of the delay portion 304 and the other input terminal is connected to one output terminal of the clock signal control portion 113. The output terminal is connected to the input terminals of the delay portion 304 and the correlation value storing portion 305. The delay portion 304 is input the addition result 303a, stores it for predetermined time and outputs the delayed addition result 304a. The delay portion 304 has one input terminal and one output terminal. The input terminal is connected to one output terminal of the addition portion 303 and the output terminal is connected to one input terminal of the addition portion 303. The correlation value storing portion 305 stores the addition result 303a and outputs the final correlation value 111a and the halfway correlation value 111b. The correlation value storing portion 305 has two input terminals and two output terminals. One input terminal is connected to one output terminal of the addition portion 303 and the other input terminal is connected to one output terminal of the clock signal control portion 113. One output terminal is connected to one input terminal of a correlation value comparing portion 501 and the other output terminal is connected to one input terminal of a comparator 403.

The comparator portion 112 is shown in FIG. 4, in detail. The comparator portion 112 has a counter 401, a correlation value storing portion 402 and a comparator 403. The counter 401 counts the code length of the multiplication result 302a by counting the number of inputting multiplication result 302a until the number of the threshold value (counter value) 104e and outputs a signal 401 a showing the end of the count. The counter 401 has three input terminals and one output terminal. One input terminal is connected to one output terminal of the multiplication portion 302, another input terminal is connected to one output terminal of the control portion 104 and the other input terminal is connected to one output terminal of the clock signal control portion 113. The output terminal is connected to one input terminal of the comparator 403. The correlation value storing portion 402 stores the threshold value 104b which is output by the control portion 104 and outputs it as the threshold value 402a. The correlation value storing portion 402 has two input terminals and one output terminal. One input terminal is connected to one output terminal of the control portion 104 and the other input terminal is connected to one output terminal of the clock signal control portion 113. The output terminal is connected to one input terminal of the comparator 403. The comparator 403 inputs the halfway correlation value 111b and the threshold value 402a at timing in inputting the signal 401a, compares the halfway correlation value 111b and the threshold value 402a, decides whether the partial correlation portion 111 keeps calculating to the very end to get the final correlation value 111 a or not and outputs the decision result 112a. The comparator 403 has four input terminals and one output terminal. One input terminal is connected to one output terminal of the correlation value storing portion 305, another input terminal is connected to one output terminal of the counter 401, another input terminal is connected to one output terminal of the clock signal control portion 113 and the other input terminal is connected to one output terminal of the correlation value storing portion 402. The output terminal is connected to one input terminal of the clock signal control portion 113.

The searcher circuit 150 retrieves a peak value from each final correlation value, respectively. The searcher circuit 150 is shown in FIG. 5, in detail. The searcher circuit 150 has a correlation value comparing portion 501 and a threshold value storing portion 502. The correlation value comparing portion 501 selects one final correlation value which has the largest value among the final correlation value, as a peak value. The correlation value comparing portion 501 compares the selected final correlation value and a threshold value 502a and outputs a comparison result 150a. The correlation value comparing portion 501 searches the correlation calculating circuit which is synchronized with the base station most by searching the correlation calculating circuit having the peak value which is larger than the threshold value 502a. The correlation value comparing portion 501 has two input terminals and one output terminal. One input terminal is connected to one output terminal of the correlation value storing portion 305 and the other input terminal is connected to one output terminal of the threshold value storing portion 502. The output terminal is connected to one input terminal of CPU 601. The threshold value storing portion 502 stores the threshold value 104c which is output by CPU 601 and outputs it as the threshold value 502a. The threshold value storing portion 502 has one input terminal and one output terminal. The input terminal is connected to one output terminal of CPU 601 and the output terminal is connected to one input terminal of the correlation value comparing portion 501.

The control portion 104 controls the acquisition circuit 100 and a finger circuit (not shown). The control portion 104 is shown in FIG. 6, in detail. The control portion 104 has a CPU (or DSP) 601 and a Random Access Memory (RAM) 602. The CPU 601 carries out the program which is stored in the RAM 602 and controls the acquisition circuit 100 et al. The CPU 601 has two input terminals and three output terminals. One input terminal is connected to one output terminal of the RAM 602 and the other input terminal is connected to one output terminal of the correlation value comparing portion 501. One output terminal is connected to the input terminals of the code generating portion 301, the counter 401 and the correlation value storing portion 402. Another output terminal is connected to one input terminal of the threshold value storing portion 502 and the other output terminal is connected to the finger circuit (not shown). The RAM 602 stores a program et al. that CPU 601 sets the threshold value 104a-104c and 104e. The RAM 602 has one input/output terminal which is connected to one input terminal of the CPU 601.

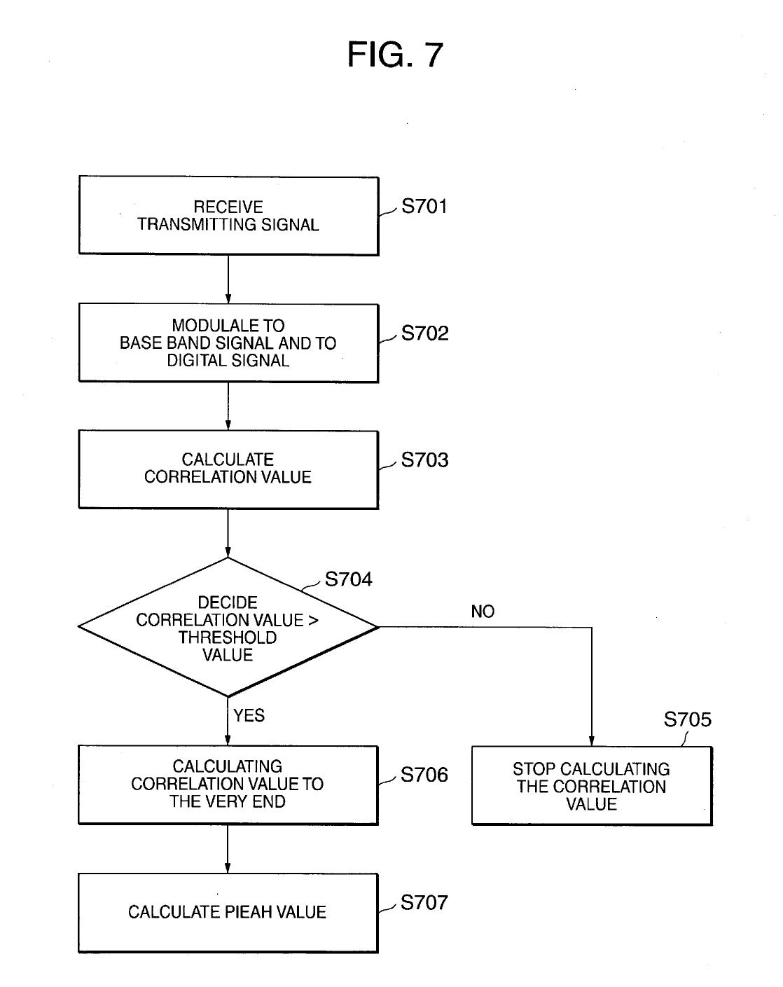

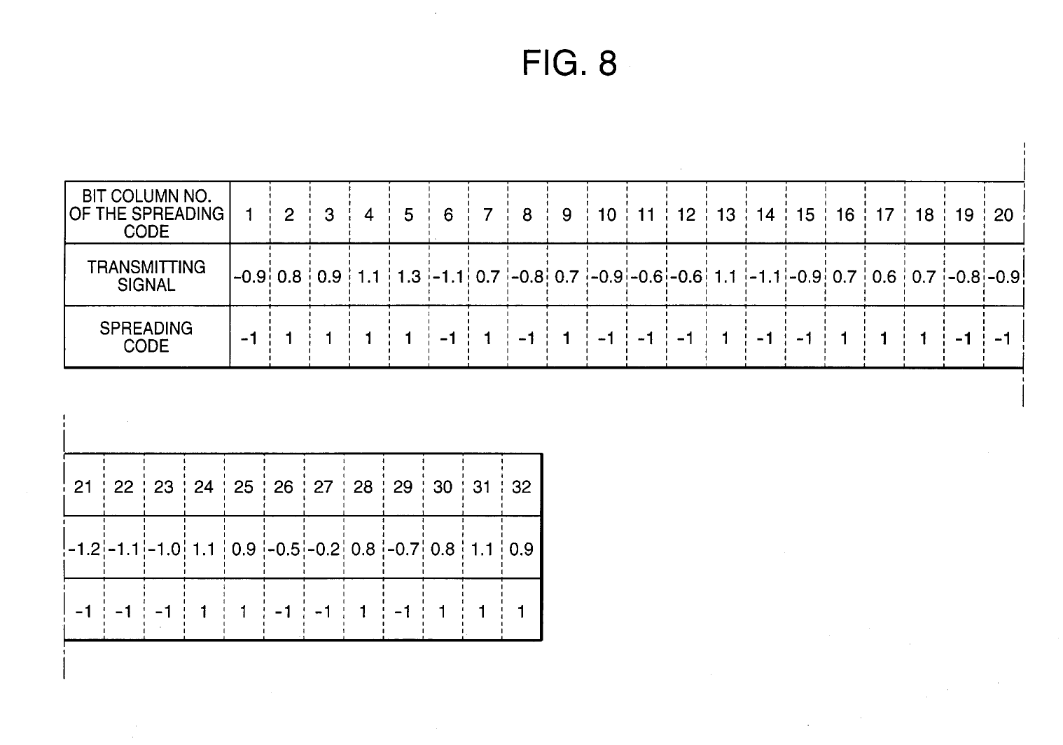

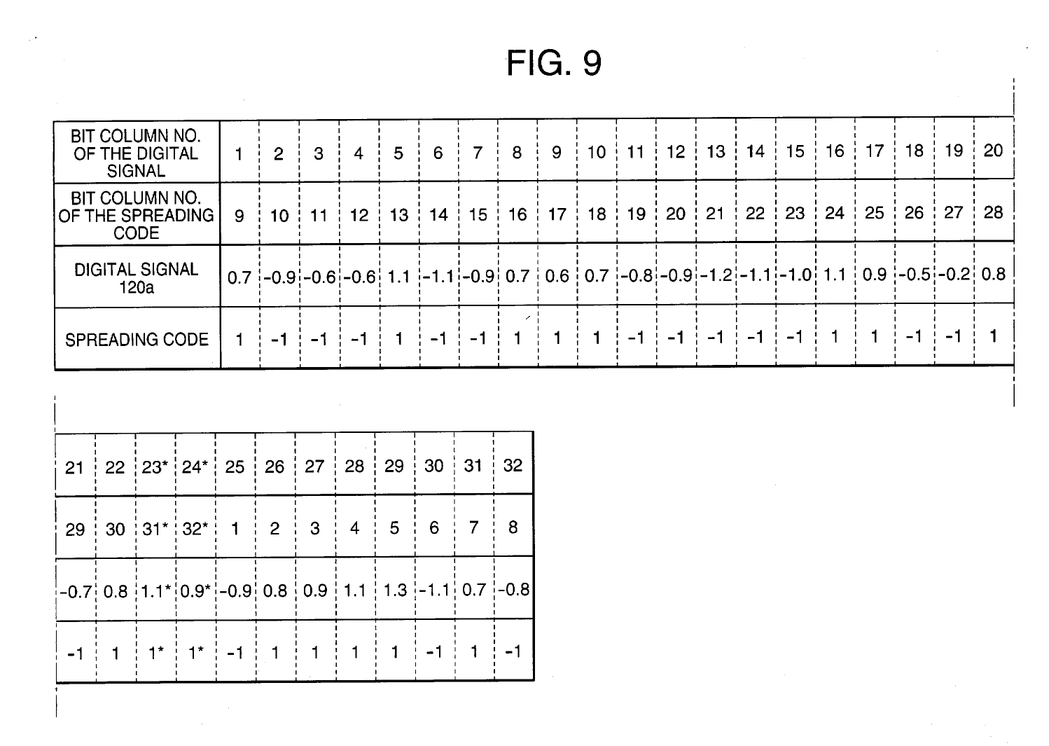

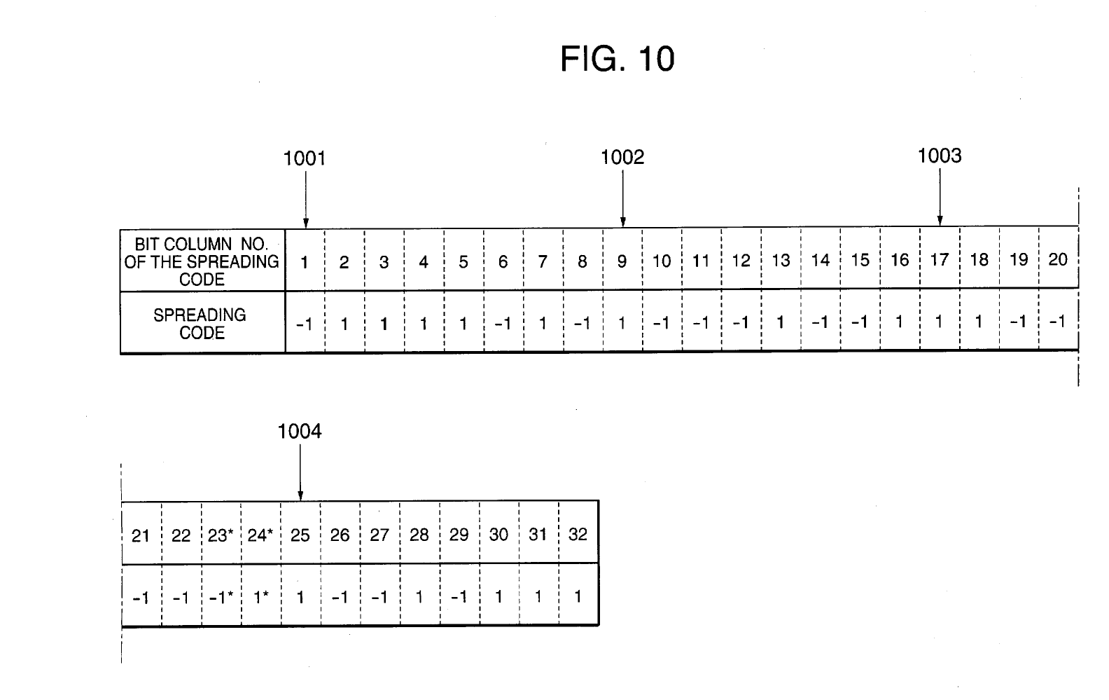

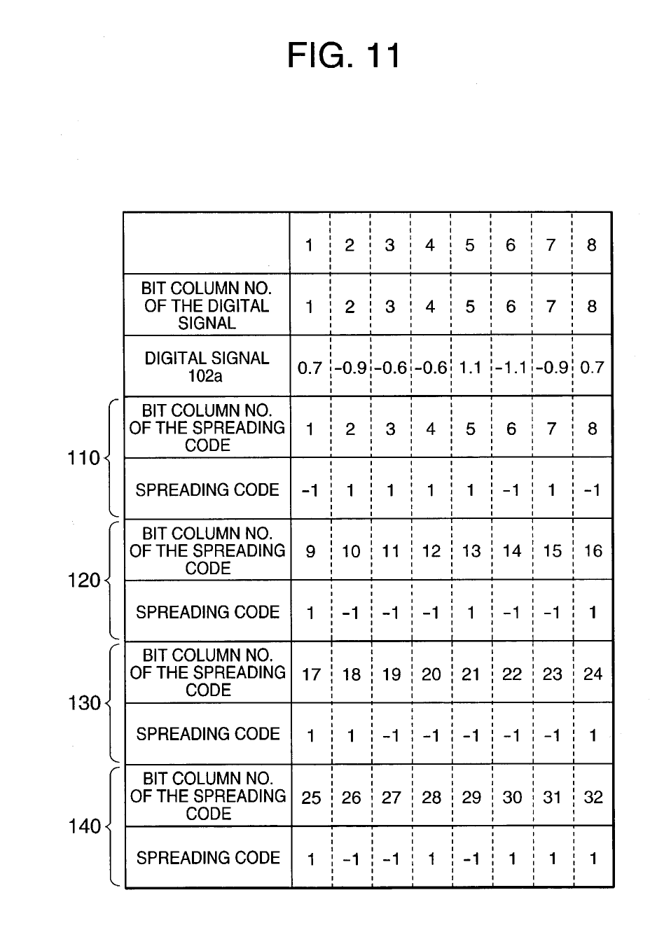

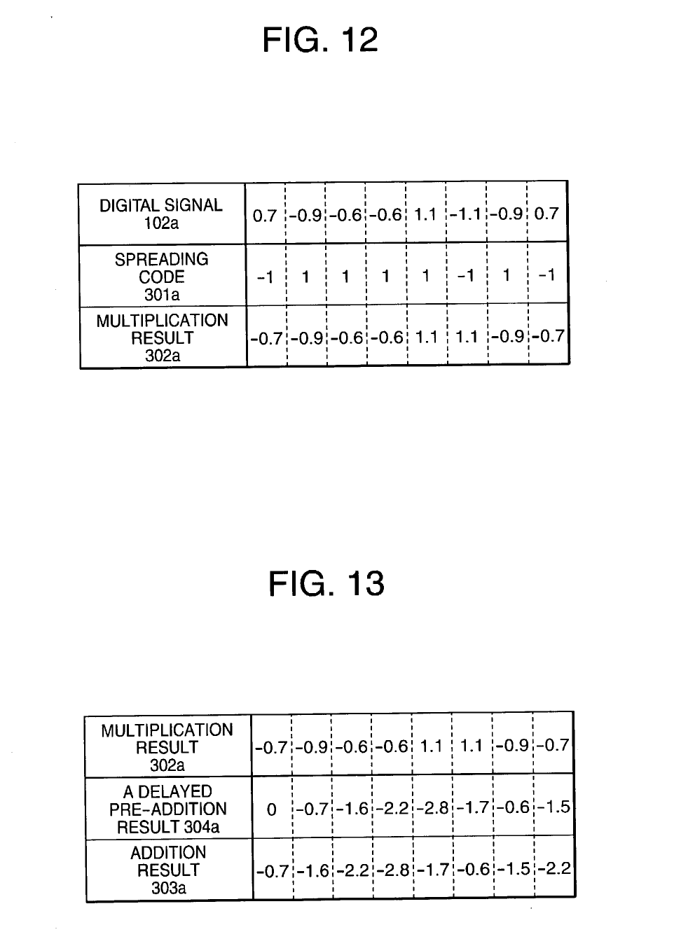

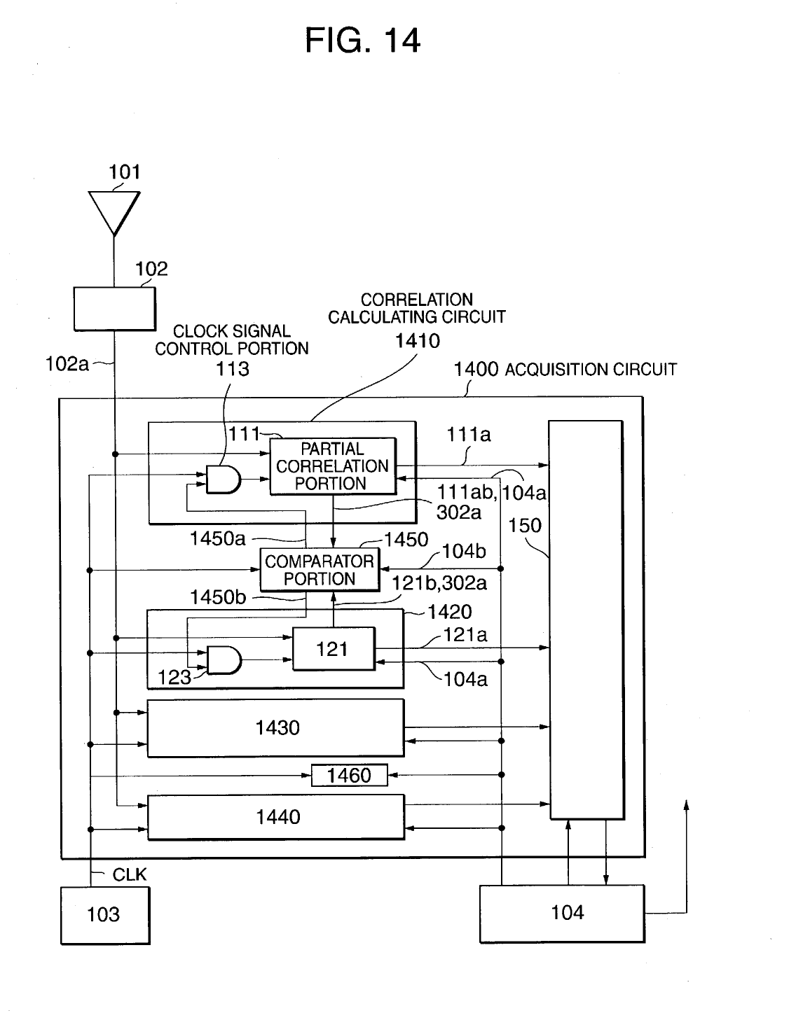

The Operation of the wireless communication apparatus according to the first preferred embodiment of the present invention will be explained with FIGS. 1-13. FIG. 7 is an operational diagram showing a wireless communication apparatus. FIG. 8 is a table showing a transmitting signal which is spread by a spreading code in the base station. FIG. 9 is a table showing a digital signal which is modulated in a radio portion. FIG. 10 is a table showing a timing of code generating in the code generating portion. FIG. 11 is a table showing a spreading code which is generated in a code generating portion. FIG. 12 is a table showing an operation of a multiplication portion. FIG. 13 is a table showing an operation of an addition portion.

The antenna portion 101 receives a transmitting signal which is spread by the spreading code in the base station and outputs a received signal 101a to the radio portion 102 (S701). For example, the transmitting signal and the spreading code are shown in FIG. 8. If the spreading timing in the receiving side (the mobile station) is equal to the spreading timing in the transmitting side (the base station), the receiving signal becomes equal to the transmitting signal shown in FIG. 8. Usually, at first, the spreading timing in the receiving side is not equal to the spreading timing in the transmitting side, so the acquisition circuit is required. In FIG. 8, the spreading code is shown using “1” or “−1”. An electric circuit realizes “1” using the supply voltage (VDD) and “−1” using the ground voltage (GND).

The radio portion 102 modulates the received signal 101a to a base band signal, modulates it from an analog signal to a digital signal and outputs the digital signal 102a (S702). For example, the digital signal 102a and the spreading code are shown in FIG. 9. Usually, at first, the spreading timing in the receiving side is not equal to the spreading timing in the transmitting side. As shown in FIG. 9, the bit column numbers of the digital signal and the spreading code differ from each other. For example, the bit column No. 1 of the digital signal corresponds to the bit column No. 9 of the spreading code in FIG. 9.

The partial correlation portion 111 calculates the correlation value 111 a and 111b (S703). The detail operation will be explained with FIG. 3 as follows. The code generating portion 301 generates the spreading code 301a as the base station uses based on the control signal (threshold value) 104a during being supplied the active clock signal CLK. Each code generating portion of each partial correlation portion generates the spreading code at different timing each other. For example, each timing of code generating in each code generating portion is shown in FIG. 10. The code generating portion 301 of the partial correlating portion 111 starts to generate the spreading code at the bit column No.1 of the spread code (point 1001). In the same way, the code generating portion of the partial correlating portion 120 starts to generate the spreading code at the bit column No.9 (point 1002). The code generating portion of the partial correlating portion 130 starts to generate the spreading code at the bit column No.17 (point 1003). The code generating portion of the partial correlating portion 140 starts to generate the spreading code at the bit column No.25 (point 1004). FIG. 11 shows the spreading code which is generated in a code generating portion, when the threshold value 104a is eight. In this example, each code generating portion generates the spreading code which comprises 8-bits as shown in FIG. 11. The multiplication portion 302 carries out the multiplication operation of the digital signal 102a and the spreading code 301a and outputs the multiplication result 302a during being supplied the active clock signal CLK, by one bit. FIG. 12 shows an operation of the multiplication portion 302. For example, when the digital signal 102a is “0.7” and when the spreading code 301 a is “−1”, the multiplication result 302a is “−0.7” (=0.7 * (−1)). The addition portion 303 carries out the addition operation of the multiplication result 302a and the delayed addition result 304a and outputs the addition result 303a, by one bit. FIG. 13 shows an operation of the addition portion 303. For example, when the multiplication result 302a is “−0.7” and when the delayed addition result 304a is “0”, the addition result 303a is “−0.7” (=(−0.7)+0). In the same way, when the multiplication result 302a is “−0.9” and when the delayed addition result 304a is “−0.7”, the addition result 303a is “−1.6” (=(−0.9)+(−0.7)). The delay portion 304 is input the addition result 303a, stores it for predetermined time and outputs the delayed addition result 304a. For example, as shown in FIG. 13, the delay portion 304 stores the addition result 303a, “−0.7”, and outputs it at timing in being output the multiplication result 302a, “−0.9”. The correlation value storing portion 305 stores the addition result 303a and outputs the final correlation value 111a and the halfway correlation value 111b during being supplied the active clock signal CLK.

The comparator portion 112 compares the halfway correlation value 111b and the threshold value 402a (S704). The detail operation will be explained with FIG. 4 as follows. The counter 401 counts every inputting the multiplication result 302a until the counting value becomes the number of the threshold value 104e during being supplied the active clock signal CLK. When the counting value is equal to the number of the threshold value 104e, the counter 401 stops counting and outputs the signal 401 a showing the end of the count. The correlation value storing portion 402 stores the threshold value 104b and outputs it as the threshold value 402a during being supplied the active clock signal CLK. The comparator 403 is input the halfway correlation value 111 b and the threshold value 402a at timing in being input the signal 401 a and compares the halfway correlation value 111 b and the threshold value 402a during being supplied the active clock signal CLK. If the halfway correlation value 111 b is larger than the threshold value 402a, the comparator 403 outputs the decision result 112a showing that the partial correlation portion 111 keeps calculating to the very end to get the final correlation value 111a. If not, the comparator 403 outputs the decision result 11 2a showing that the partial correlation portion 111 stops calculating to get the final correlation value 111a.

The clock signal control portion 113 inputs the clock signal CLK which is output by the clock signal generating portion 103 and the decision result 112a. If the decision result 112a showing that the partial correlation portion 111 keeps calculating to the very end to get the final correlation value 111a is input, the clock signal control portion 113 outputs the clock signal CLK to the later circuit. In other words, when the decision result 112a which has the supply voltage level (“H” level) is input, the clock signal control portion 113 outputs the clock signal CLK to the later circuit. If not, the clock signal control portion 113 does not output the clock signal CLK to the later circuit. In other words, when the decision result 11 2a which has the ground voltage level (“L” level) is input, the clock signal control portion 113 does not output the clock signal CLK to the later circuit. The later circuit which does not receive the clock signal CLK does not operate. Therefore, the correlation calculating circuit can stop calculating the final correlation value 111a (S705). All correlation calculating circuits which are input the active clock signal CLK output by the clock signal control portion 103, keeps calculating to the very end to get the final correlation value 111a (S706).

The searcher circuit 150 retrieves a peak value from each final correlation value which is output by each acquisition circuit, respectively (S707). The detail operation will be explained with FIG. 5 as follows. The threshold value storing portion 502 input the threshold value 104c which is output by CPU 601, stores it for predetermined time and outputs the stored threshold value 104c as the threshold value 502a. The correlation value comparing portion 501 input the final correlation value which is output by each acquisition circuit. By the way, there are three situations in the searcher circuit 150. A first situation is that the searcher circuit 150 receives a plurality of the final correlation value output by a plurality of the correlation calculating circuits. A second is that it receives only one final correlation value output by only one the correlation calculating circuit. A third is that it does not receive the final correlation value at all. If the searcher circuit 150 in the first situation inputs two or more final correlation value, the correlation value comparing portion 501 compares the input final correlation value each other. The correlation value comparing portion 501 detects one final correlation value (a peak value) having the largest value from two or more final correlation value. The correlation value comparing portion 501 compares the peak value and the threshold value 502a. The correlation value comparing portion 501 decides that the correlation calculating circuit which is output the final correlation value as the peak value is synchronized with the base station and outputs the comparison result 150a showing that, if the peak value is larger than the threshold value 502a. If the searcher circuit 150 receives only one final correlation value, the correlation value comparing portion 501 compares that final correlation value and the threshold value 502a in the same way. The concretely operation of the searcher circuit 150 will be explained as follows. When the correlation calculating circuit 120 outputs the final correlation value, “27.5”, and when the correlation calculating circuit 130 outputs the final correlation value, “−2.3”, and when the threshold value 502a is “20”, the correlation value comparing portion 501 compares “27.5” and “−2.3” and decides “27.5” as the peak value. Because “27.5” is larger than “−2.3”. So, the correlation value comparing portion 501 compares “27.5” and “20” and decides that the correlation calculating circuit 120 is synchronized with the base station. Because “27.5” is larger than “20”.

The control portion 104 calculates the threshold value 104b based on the strength of the signal which is calculated using the mathematical expression, P*W*Q*R,. The control portion 104 calculates the threshold value 104c by dividing the threshold value 104b by the threshold value 104e. RAM 602 has a table which stores the receiving condition of the digital signal 102a, the ratio of the signal W and the threshold value 104e. The control portion 104 sets the ratio of the signal W and the threshold value 104e based on the table. The threshold value 104e is variable in the receiving condition of the digital signal 102a. It is preferable that the threshold value 104e has small value in good receiving condition. The control portion 104 outputs the control signal 104d to the finger circuit, when the comparison result 150a showing that the correlation calculating circuit which outputs the final correlation value as the peak value is synchronized with the base station is input. The finger circuit receiving the comparison result 150a generates the spreading code at timing of the correlation calculating circuit outputting the peak value and carries out the de-spread operation for the digital signal 102a. On the other hand, the control portion 104 outputs the control signal 104a showing changing timing of the spreading code generation to all correlation calculating circuits, when the comparison result 150a not showing that the correlation calculating circuit which is output the final correlation value as the peak value is synchronized with the base station is input. Each correlation calculating circuit changes timing of the spreading code generation based on the control signal 104a and calculates the correlation value again. At this time, the threshold value 104b, 104c and 104e are changed, too.

The wireless communication apparatus according to the first preferred embodiment of the present invention can decide whether the correlation calculation circuit is synchronized with the base station in the middle of the calculation or not. The wireless communication apparatus according to the first preferred embodiment of the present invention let the correlation calculation circuit which is unlikely to be synchronized with the base station stop calculating to the very end. Therefore, the wireless communication apparatus according to the first preferred embodiment of the present invention can reduce power consumption of the wireless communication apparatus.

In addition, the wireless communication apparatus according to the first preferred embodiment of the present invention can adjust the threshold value (counter value) 104e according to the communication situation. For example, the wireless communication apparatus let the threshold value small in good communication situation and let it large in bad communication situation. In good communication situation, the wireless communication apparatus can finish comparing the halfway correlation value and the threshold value in the comparator portion comparing with in the bad communication situation. Therefore, the wireless communication apparatus according to the first preferred embodiment of the present invention can reduce power consumption of the wireless communication apparatus in good communication situation.

(Second Preferred Embodiment)

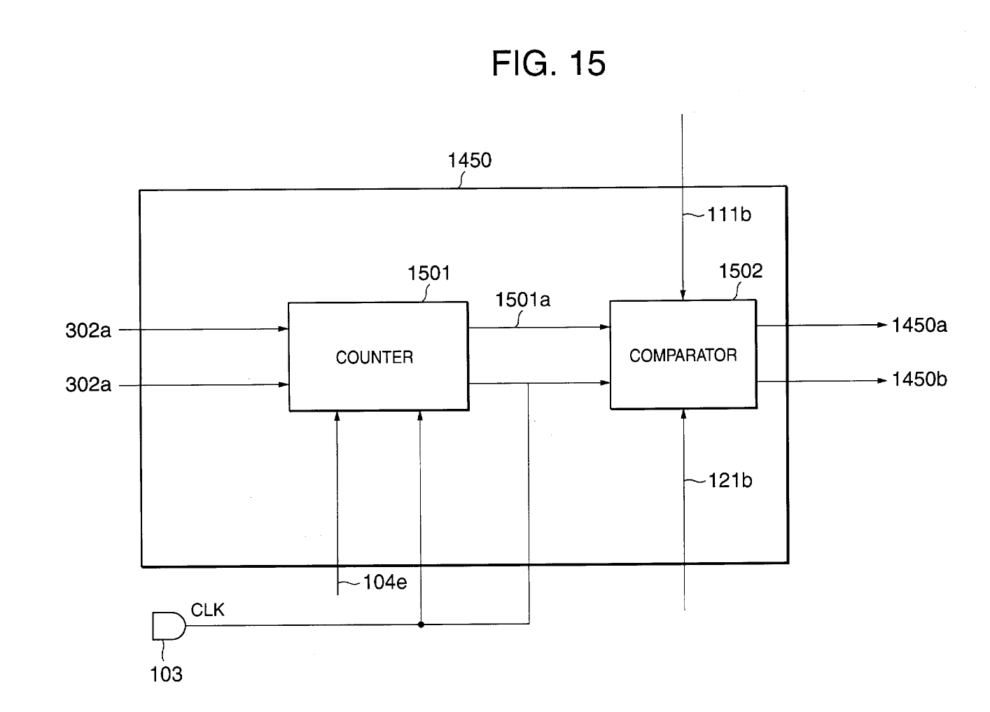

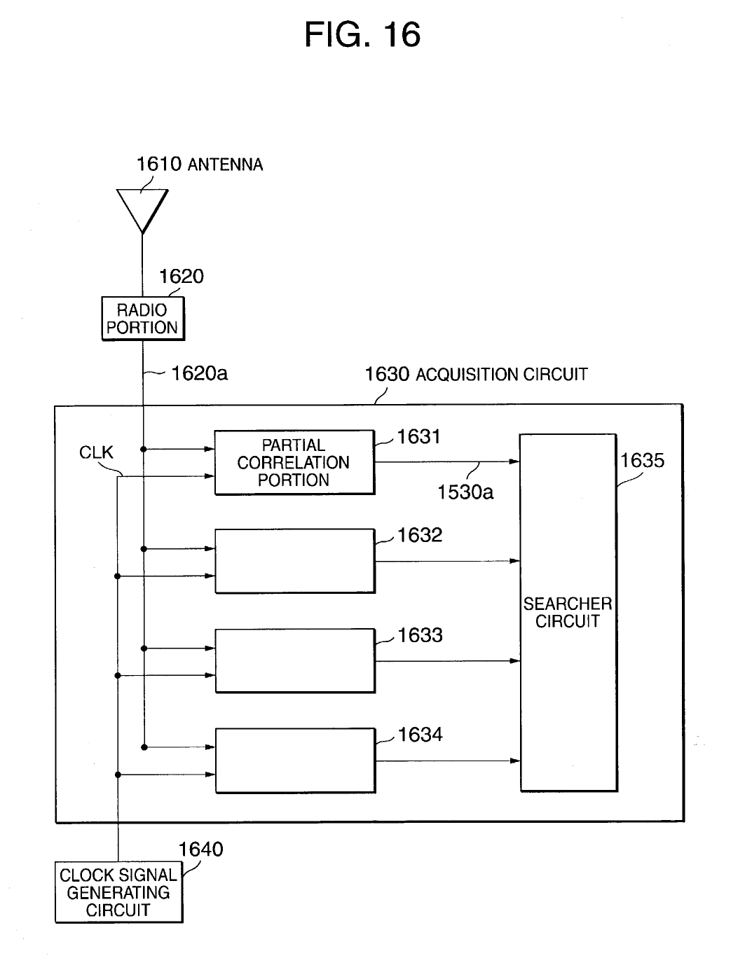

A wireless communication apparatus according to a second preferred embodiment of the present invention will be described with reference to FIGS. 14-15.

First, the composition of the wireless communication apparatus according to the second preferred embodiment of the present invention will be explained with FIGS. 14-15. FIG. 14 is a block diagram showing a wireless communication apparatus according to a second preferred embodiment of the present invention. FIG. 15 is a block diagram showing a comparator portion according to a second preferred embodiment of the present invention. Like elements are given like or corresponding reference numerals in the first and second preferred embodiments. Thus, dual explanations of the same elements are avoided.

As shown in FIG. 14, the wireless communication apparatus has an antenna portion 101, a radio portion 102, an acquisition circuit 1400, a clock signal generating portion 103 and a control portion 104.

The acquisition circuit 1400 is coupled with the radio portion 102, the clock signal generating portion 103 and the control portion 104. The acquisition circuit 1400 calculates a plurality of correlation value using a plurality of the correlation calculating circuits to acquire system synchronization effectively. The acquisition circuit 1400 has a plurality of correlation calculating circuits 1410-1440, a plurality of comparator portions 1450-1460 and a searcher circuit 150. The correlation calculating circuits and the comparator portions are set in proportion the 2 of 1. In FIG. 14, the comparator portion 1450 is set for the correlation calculating circuits 1410-1420. The comparator portion 1460 is set for the correlation calculating circuits 1430-1440. Each of the correlation calculating circuits 1410-1440 calculates correlation value which differs from each other based on the digital signal 102a. The composition of each correlation calculating circuit is same each other. The correlation calculating circuit 1410 has a partial correlation portion 111 and a clock signal control portion 113. The correlation calculating circuit 1420 has a partial correlation portion 121 and a clock signal control portion 123.

The comparator portion 1450 is shown in FIG. 15, in detail. The comparator portion 1450 has a counter 1501 and a comparator 1502. The counter 1501 counts the code length of each multiplication result 302a by counting the number of inputting each multiplication result 302a until the number of the threshold value (counter value) 104e and outputs a signal 1501 a showing the end of the count. The counter 1501 has four input terminals and one output terminal. One input terminal is connected to one output terminal of the multiplication portion in the partial correlation portion 111, another input terminal is connected to one output terminal of the multiplication portion in the partial correlation portion 121, another input terminal is connected to one output terminal of the control portion 104 and the other input terminal is connected to one output terminal of the clock signal generating portion 103. The output terminal is connected to one input terminal of the comparator 1502. The comparator 1502 inputs the halfway correlation value 111b and 121b at timing in inputting the signal 1501a, compares the halfway correlation value 111b and 121b, decides whether the partial correlation portions 111 or 121 keeps calculating to the very end to get the final correlation value 111 a or 121 a or not and outputs the decision results 1450a-1450b. The comparator 403 has four input terminals and two output terminals. One input terminal is connected to one output terminal of the correlation value storing portion in the correlation calculating circuit 1410, another input terminal is connected to one output terminal of the correlation value storing portion in the correlation calculating circuit 1420, another input terminal is connected to one output terminal of the counter 1501, the other input terminal is connected to one output terminal of the clock signal generating portion 103. One output terminal is connected to one input terminal of the clock signal control portion 113 and the other output terminal is connected to one input terminal of the clock signal control portion 123.

The operation of the wireless communication apparatus according to the second preferred embodiment of the present invention will be explained with FIGS. 14-15. Like elements are given like or corresponding reference numerals in the first and second preferred embodiments. Thus, dual explanations of the same operations are avoided.

The comparator portion 1450 compares the halfway correlation value 111b and the halfway correlation value 121b. The detail operation will be explained with FIG. 15 as follows. The counter 1501 counts every inputting the multiplication result output by the correlation calculating circuit 1410 until the counting value becomes the number of the threshold value 104e. In the same way, the counter 1501 counts every inputting the multiplication result output by the correlation calculating circuit 1420 until the counting value becomes the number of the threshold value 104e. When the counting value is equal to the number of the threshold value 104e, the counter 1501 stops counting and outputs the signal 1501a showing the end of the count.

The comparator 1502 is input the halfway correlation value 111b and the halfway correlation value 121b at timing in being input the signal 1501a and compares them. If the halfway correlation value 111b is larger than the halfway correlation value 121b, the comparator 1502 outputs the decision result 1450a showing that the partial correlation portion 111 keeps calculating to the very end to get the final correlation value 111 a. If not, the comparator 1502 outputs the decision result 1450b showing that the partial correlation portion 121 keeps calculating to the very end to get the final correlation value 121 a.

The clock signal control portion 113 inputs the clock signal CLK which is output by the clock signal generating portion 103 and the decision result 1450a. If the decision result 1450a showing that the partial correlation portion 111 keeps calculating to the very end to get the final correlation value 11 la is input, the clock signal control portion 113 outputs the clock signal CLK to the later circuit. In other words, when the decision result 1450a which has the supply voltage level (“H” level) is input, the clock signal control portion 113 outputs the clock signal CLK to the later circuit. If not, the clock signal control portion 113 does not output the clock signal CLK to the later circuit. In other words, when the decision result 1450a which has the ground voltage level (“L” level) is input, the clock signal control portion 113 does not output the clock signal CLK to the later circuit. The later circuit which does not receive the clock signal CLK does not operate. Therefore, the correlation calculating circuit can stop calculating the final correlation value 111a. In the same way, the clock signal control portion 123 inputs the clock signal CLK which is output by the clock signal generating portion 103 and the decision result 1450b. If the decision result 1450b showing that the partial correlation portion 121 keeps calculating to the very end to get the final correlation value 121a is input, the clock signal control portion 123 outputs the clock signal CLK to the later circuit. In other words, when the decision result 1450b which has the supply voltage level (“H” level) is input, the clock signal control portion 123 outputs the clock signal CLK to the later circuit. If not, the clock signal control portion 123 does not output the clock signal CLK to the later circuit. In other words, when the decision result 1450b which has the ground voltage level (“L” level) is input, the clock signal control portion 123 does not output the clock signal CLK to the later circuit. The later circuit which does not receive the clock signal CLK does not operate. Therefore, the correlation calculating circuit can stop calculating the final correlation value 121 a.

For example, when the halfway correlation value 111b is “−2.2” and when the halfway correlation value 121b is “6.6”, the comparator 1502 compares “−2.2” and “6.6”. The comparator 1502 outputs the decision result 1450a which has the ground voltage level (“L” level) and the decision result 1450b which has the supply voltage level (“H” level). Because “6.6” is larger than “−2.2”. The clock signal control portion 113 does not output the active clock signal CLK to the later circuit and the clock signal portion 123 outputs the active clock signal CLK to the later circuit.

As the wireless communication apparatus according to the first preferred embodiment, the wireless communication apparatus according to the second preferred embodiment of the present invention can reduce power consumption of the wireless communication apparatus.

In addition, as the wireless communication apparatus according to the first preferred embodiment, the wireless communication apparatus according to the second preferred embodiment of the present invention can reduce power consumption of the wireless communication apparatus in good communication situation.

In addition, the wireless communication apparatus according to the second preferred embodiment of the present invention set the common comparator portion rather than individual comparator portions. Therefore, the wireless communication apparatus according to the second preferred embodiment of the present invention can reduce a circuit area.

In addition, the wireless communication apparatus according to the second preferred embodiment of the present invention does not need the threshold value 104b as the wireless communication apparatus according to the first preferred embodiment uses. The wireless communication apparatus according to the second preferred embodiment of the present invention needs not to program for CPU to set the threshold value. Therefore, the wireless communication apparatus according to the second preferred embodiment of the present invention can reduce CPU's burden.

While the preferred form of the present invention has been described, it is to be understood that modifications will be apparent to those skilled in the art without departing from the spirit of the invention. For example, the acquisition circuits shown in the first and second preferred embodiment have four correlation circuits each other. However, the number of the correlation circuits is not restricted to four. In addition, each correlation calculating circuit shown in the first preferred embodiment has the same threshold value 104b. However, the correlation calculating circuit does not need necessarily having the same threshold value each other. In addition, the comparator portion shown in the second preferred embodiment is provided against the correlation calculating circuit in the proportion of 2 to 1. However, the proportion is not restricted such as. The comparator portion may be provided in the proportion of 4 to 1. In addition, the clock signal control portion 113 in the above preferred embodiments comprises with AND circuit. However, the clock signal control portion 113 may comprise with the power supply circuit as shown in the conventional wireless communication apparatus is shown in Japanese Patent Application Laid-open No. 2000-138654.

The scope of the invention, therefore, is to be determined solely by the following claims.

What is claimed:

1. A wireless communication apparatus having an acquisition circuit in CDMA system, wherein the acquisition circuit has;
a partial correlation portion which generates a first correlation value;
a comparator portion which compares the first correlation value and a first threshold value and outputs a first comparison result; and
a clock signal control portion which supplies a clock signal to the partial correlation portion based on the comparison result.

2. The wireless communication apparatus according to claim 1, wherein the partial correlation portion generates a second correlation value based on the comparison result.

3. The wireless communication apparatus according to claim 2, the acquisition circuit further comprising;
a searcher circuit which selects a peak value of the second correlation value, compares the peak value and a second threshold value and outputs a second comparison result.

4. The wireless communication apparatus according to claim 1, wherein the partial correlation portion has
a code generating portion which generates a spreading code;
a multiplication portion which carries out the multiplication operation of a digital signal and the spreading signal and outputs a multiplication result;
a delay portion which stores an addition result for certain time and outputs a delayed addition result;
an addition portion which carries out the additional operation of the multiplication result and the delayed addition result and outputs the addition result; and
a correlation value storing portion which stores the addition result and outputs a first correlation value or a second correlation value.

5. The wireless communication apparatus according to claim 4, wherein the comparator portion has
a counter which counts the length of the multiplication result until a certain value and outputs a signal; and
a comparator which compares the first correlation value and the first threshold value and outputs the first comparison result.

6. The wireless communication apparatus according to claim 5, wherein the clock signal control portion comprises with an AND circuit.

7. A wireless communication apparatus in CDMA system comprising;
a plurality of correlation calculating circuits, wherein each correlation calculating circuit has a partial correlation portion which generates a first correlation value and a second correlation value during being supplied a clock signal and a clock signal control portion which supplies the clock signal to the partial correlation portion based on a first comparison result;
a comparator portion which inputs a plurality of first correlation value output by each correlation calculating circuit, compares the plurality of first correlation value and generates the first comparison result.

8. The wireless communication apparatus according to claim 7, the acquisition circuit further comprising;
a searcher circuit which selects a peak value of the second correlation value, compares the peak value and a first threshold value and outputs a second comparison result.

9. The wireless communication apparatus according to claim 8, wherein the partial correlation portion has
a code generating portion which generates a spreading code;
a multiplication portion which carries out the multiplication operation of a digital signal and the spreading signal and outputs a multiplication result;
a delay portion which stores an addition result for certain time and outputs a delayed addition result;
an addition portion which carries out the additional operation of the multiplication result and the delayed addition result and outputs the addition result; and
a correlation value storing portion which stores the addition result and outputs a first correlation value or a second correlation value.

10. The wireless communication apparatus according to claim 9, wherein the comparator portion has
a counter which counts the length of the multiplication result until a certain value and outputs a signal; and
a comparator which compares the plurality of first correlation value and generates a plurality of first comparison results.

11. The wireless communication apparatus according to claim 10, wherein the clock signal control portion comprises with an AND circuit.

12. A method of a wireless communication apparatus, the method comprising;
receiving a transmitting signal which is output by a base station;
modulating the transmitting signal to a base band signal;
modulating the base band signal from an analog signal to a digital signal;
comparing the digital signal and a spreading code and generating a first correlation value;
comparing the first correlation value and a threshold value and generating a comparison result;
supplying a clock signal based on the comparison result; and
generating a second correlation value during being supplied the clock signal.
